(19) United States
(12) Patent Application Publication
(10) Pub. No.: US 2006/0174989 A1
(43) Pub. Date: Aug. 10, 2006

(54) Tyre for remotely operated vehicle

(75) Inventor: Christopher Peter Jones, Counden (GB)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Remotec UK Limited, Whitley (GB)

(21) Appl. No.: 11/350,571

(22) Filed: Feb. 9, 2006

(30) Foreign Application Priority Data
Feb. 9, 2005 (GB) 0502605.9

(51) Int. Cl. B60C 7/00

(52) U.S. Cl. 152/246

(57) ABSTRACT

The present invention discloses a tyre whose stiffness in its radial direction varies around its circumference. Preferably, the tyre is adapted to fit one or more wheels of a stair-climbing vehicle and its radial stiffness varies so as to allow the tyre to grip one or more stairs in use.

### FIELD OF THE INVENTION

The present invention relates to a tyre and related apparatus for a remotely operated vehicle. In particular, the present invention relates predominantly, but not exclusively, to a tyre that is adapted to cope with undulating terrain such as stairs, kerbs, and rough ground; to wheels fitted with the tyre; and to remotely operated vehicles fitted with such wheels.

### BACKGROUND ART

Before the present invention, it was possible for remotely-operated vehicles to cope with undulating terrain, but in order to obtain the traction required it was necessary to ensure that their tyres were only partially pneumatically filled. The consequence of this is that the tyres then only had a short life span in use.

There remains a need to provide a resilient tyre that can cope with undulating terrain. Stairs and kerbs present difficulties, as does some terrain such as sand, shingle, mud, rough ground and rubble.

### SUMMARY OF THE INVENTION

It is thus an aim of the present invention to provide an improved tyre without the disadvantages of the prior art. Typically, such an improved tyre should allow remotely-operated vehicles to cope with difficult terrain more efficiently.

In a first aspect, the present invention therefore provides a tyre adapted to fit one or more wheels of a remotely operated vehicle whose stiffness in its radial direction varies around its circumference.

Preferably, the tyre is non-pneumatic. That is, it may comprise parts that are not inflated, but are solid although resiliently deformable.

Preferably, the tyre's radial stiffness varies so as to allow the tyre to grip one or more stairs in use. This enables efficient leverage for climbing sets of stairs to be provided.

In one embodiment, the variable stiffness is effected by a localised reduction in stiffness in one or more discrete zones around the circumference of the tyre. Usually, the discrete zones are regularly spaced around the circumference of the tyre. Preferably, each discrete zone is formed of a collapsible area of resilient means.

Typically, the number of discrete zones is:
(a) one or more;
(b) five or more; or
(c) no greater than 100.

In another embodiment, the tyre comprises an inner ring of one or more sprockets encased in an outer ring of a resilient material. The outer ring of resilient material allows the tyre to grip one or more stairs in use, whilst the sprockets encourage the wheel to move so that an adjacent thicker portion of resilient material is engaged with each stair.

In another variation, the one or more inner sprockets may be sandwiched between two or more outer layers of resilient material. Alternatively, the one or more inner sprockets may be arranged beside a single layer of resilient material.

Preferably, the sprockets are composed of polymer and/or the resilient material is rubber.

In another embodiment, a discrete, sprung tooth may pass from each sprocket in a radial direction towards the circumferential edge of the overlying outer ring of resilient material. Here, the sprung tooth is able to move radially to allow the outer surface above the tooth to engage a stair in use.

In yet another embodiment, the one or more collapsible areas include at least one internal compartment within the resilient material. As an internal compartment engages a stair (or other point load) it collapses so as to grip the stair and provide stair climbing leverage.

The at least one compartments may be filled with a material of lower stiffness, or may alternatively be empty.

Preferably, each compartment is adapted to collapse in use as the area around it encounters a point load.

In a second aspect, the present invention provides a wheel comprising a tyre as described above.

In a third aspect, the present invention provides a vehicle comprising a wheel as described above.

### BRIEF DESCRIPTION OF THE DRAWINGS

An embodiment of the present invention will now be described by way of example, with reference to the accompanying figures in which;

FIG. 1 shows a side view of a first embodiment of the present invention in which an internal sprocket is encased in an outer layer of resilient material;

FIG. 2A illustrates a plan view of a second embodiment in which an inner sprocket is sandwiched between two layers of resilient material;

FIG. 2B illustrates a plan view of a related, third embodiment in which an inner sprocket is bounded by a single outer layer of resilient material;

FIG. 3 depicts a version of the embodiment shown in FIG. 1;

FIG. 4 shows a sprung-tooth sprocket arrangement of yet another embodiment;

FIG. 5 illustrates an arrangement in which the resilient material comprises inner compartments according to yet another embodiment;

FIG. 6 shows a view from the side of a further embodiment of tyre;

FIG. 7 shows a view from the side of a related embodiment;

FIG. 8 shows a view from the circumference f the embodiment of FIG. 6 or 7;

FIGS. 9 and 10 show views of the reaction of the tyres of FIGS. 6 and 7 to flat and point loads respectively; and

FIG. 11 shows yet a further embodiment of the present invention.

### DETAILED DESCRIPTION OF THE EMBODIMENTS

In the following description, the embodiments will be described in the context of climbing stairs, a significant problem in the known art. However, it will be appreciated that similar technical difficulties apply to the other contexts discussed above, and it should therefore be understood that the described embodiments are equally applicable to and advantageous in other forms of undulating terrain.

In FIG. 1, a wheel 10 is shown having a tyre 12, comprising an inner aluminium sprocket 14 covered in an outer encasement of resilient material 16. In use, when the wheel 10 encounters a stair, the resilient material 16 will deform radially inwards towards the centre of the wheel 10. The tyre 12 will grip the stair if sufficient deformation occurs. This happens when the teeth of the sprocket 14 are aligned such that deformation can continue in between the teeth. If alignment is not so, the wheel 10 will slip around, driven until alignment is correct, and the tyre 12 can grip accordingly.

Thus, when presented with a series of steps, the wheel essentially presents the toothed arrangement of the stiffer aluminium sprockets 14. When running on a flat surface, on the other hand, the wheel can present the softer smooth surface of the resilient material 16. Thus, the wheel has stair-climbing ability but can also provide a smooth ride.

The tyre 12 has a continuous rim formed by a band 18 of resilient material. This provides some circumferential rigidity to the tyre, to offer a smoother ride over flat surfaces.

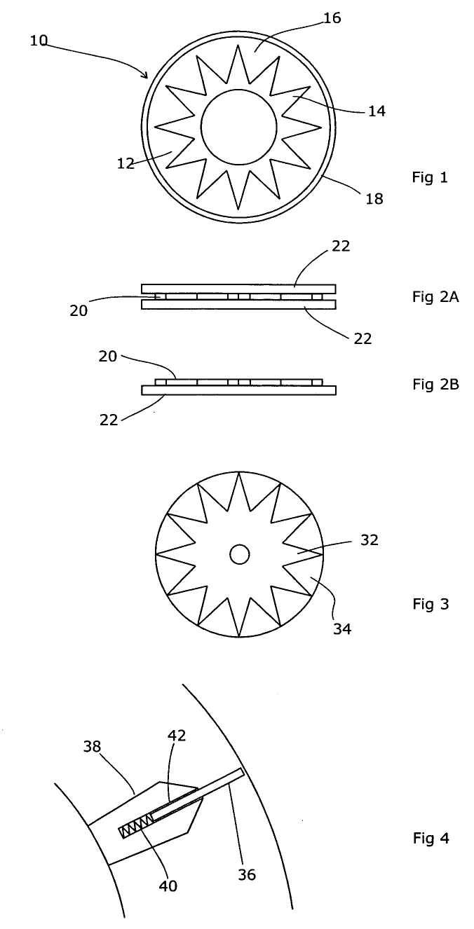

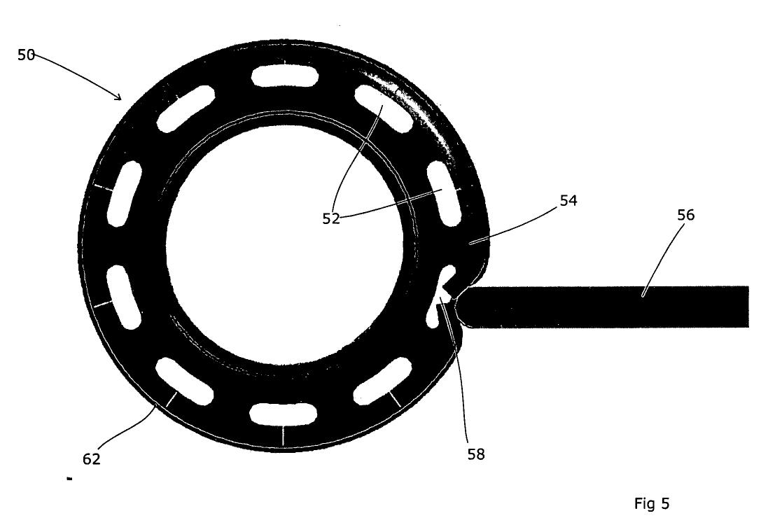

In another example, shown in FIGS. 2A and B, the inner sprocket 20 may be either sandwiched between two outer layers of resilient material 22 (see FIG. 2A) or bounded by just one such layer (see FIG. 2B). Operation of the tyre is the same as described above.

FIG. 3 shows a further embodiment in which the sprocket 32 extends right out to the surface of the tyre such that less resilient material 34 is present. This likewise operates in the same manner.

In FIG. 4, another arrangement is shown. Here a tooth 36 is attached to a hollow section of the sprocket 38 by a spring means 40 within a channel 42. This tooth 36 will offer some additional resilience when rolling on flat ground but will be circumferentially rigid when engaging the edge of a step by virtue of its location in the channel 42.

The further example illustrated in FIG. 5 shows a tyre 50 having a plurality of inner compartments 52. At least an outer section 54 of the tyre is composed of resilient material, in which the compartments 52 are formed. Thus, when the tyre 50 encounters a stair 56, the relevant compartment 58 collapses, thus allowing for deformation of the rim 54 so that the stair 56 may be gripped. Should no compartment be aligned with the stair 56, the tyre 50 will slip until such correct alignment is in fact present.

As shown in FIG. 5, slits 60 extend from the compartments 52 towards the rim of the tyre. In this case, the slits extend through the outer section 54 but stop short of a circumferential cover 62. These slits may assist in encouraging the described deformation of the tyre. However, in many instances they may be superfluous.

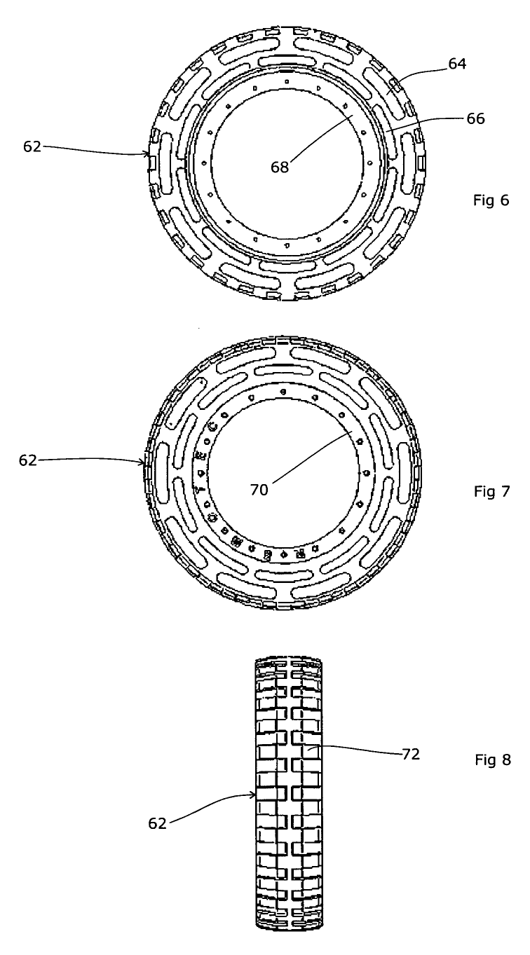

FIGS. 6 and 7 show a still further embodiment. This resembles the embodiment of FIG. 5 in that the tyre 62 has compartments within the resilient material, but is distinguished by the compartments being arranged as a number of spaced open ‘cells’ 64 arranged on a pitch circle close to its outer circumference. A second group of cells 66 are arranged on a smaller pitch circle, positioned ½ of one pitch out from the outer group 64. This allows the web of material left present between the outer cells 64 to collapse into the cavity of the inner cell 66, equalising the compliance of the tyre when rotating and thus transitioning from cell to web. This keeps the vibration induced by the rolling tyre to a minimum.

The number, shape of cells and material hardness may be varied to provide tyres with specific characteristics. In this example, 10 equally spaced cells 64, 66 are provided in each group. However, this could be adjusted as required.

The tyre is moulded around a rigid interface ring or hub 68 that maintains it roundness in operation. Various alternative forms of hub 70 are possible, as shown in FIG. 7.

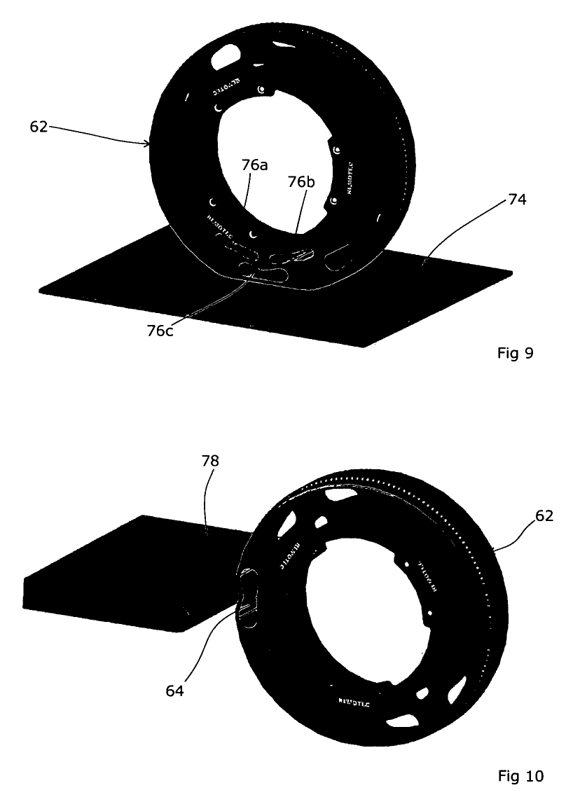

The exterior circumference of the tyre 62 can be provided with a thread pattern 72, as shown in FIG. 9.

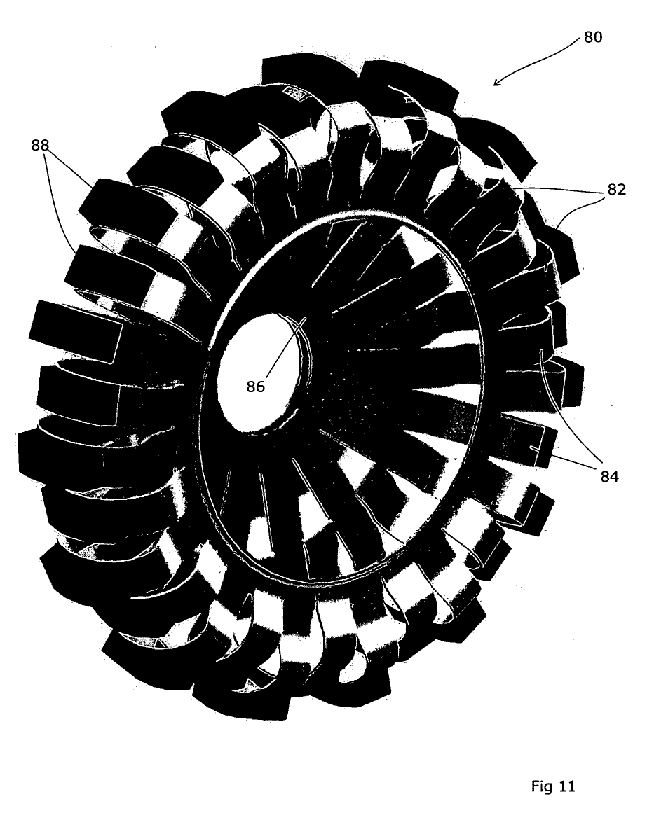

In use, as shown in FIGS. 9 and 10, the tyre can display smoother rolling characteristics due to the double layer of cells 64, 66. FIG. 9 shows the tyre 62 on a flat surface 74, with various cells 76a, 76b, 76c being deformed under the load although the aggregate radial stiffness throughout the tyre 62 is generally the same at all circumferential points. As a result, the tyre 62 rolls smoothly.

As shown in FIG. 10, however, the varying radial stiffness in the outer section of the tyre 62 means that the outer cells 64 thus deform in on themselves when point loads 78 are applied against them, such as stair treads and kerbs. This allows the tyre 62 to grip in a positive manner and gain traction enabling a vehicle to climb the obstacle 78.

In FIG. 11, a further embodiment is shown in which the wheel 80 comprises discrete outer 82 and inner 84 bands of aluminium bent so as to provide some resiliency in their arrangement around a central hub 86. The outermost surfaces of both the outer 82 and inner 84 bands are covered in a layer of more resilient material 88 such as rubber. In use, the inner bands 84 prove to be more deformable than their outer band 82 counterpart by virtue of the different profiles. Thus, when they engage a stair the edge thereof can be gripped between bands.

Thus, the present invention provides a tyre which is simple to construct at minimal cost, yet effectively and efficiently allows vehicles to climb stairs (etc) without the tyre perishing quickly. Preferred embodiments of the tyre are able to;
Maintain radial compliance (deformation) when climbing kerbs, stairs, and obstacles.
Increase transverse stiffness, thus reducing tyre roll with respect to the rim when cornering.
Be impervious to puncture damage.
Maintain or exceed the vibration-damping characteristics of known tyres.
Reduce friction when cornering (again attributable to the high transverse stiffness) as compared to low-inflation pneumatic tyres
Remain unaffected by external pressure changes. (e.g. during or after transportation by air)
Require little or no maintenance (such as re-inflation).

It will of course be understood that many variations may be made to the above-described embodiment without departing from the scope of the present invention.

1. A remotely-operated vehicle comprising a wheel to which is fitted a tyre, the tyre comprising a layer whose stiffness in its radial direction varies around its circumference.

2. The remotely-operated vehicle according to claim 1, wherein the tyre is non-pneumatic.

3. The remotely-operated vehicle according to claim 1, wherein its radial stiffness varies so as to allow the tyre to grip one or more undulations in use.

4. The remotely-operated vehicle according to claim 1, wherein the varying stiffness is effected by a localised reduction in stiffness in one or more discrete zones around the circumference of the tyre.

5. The remotely-operated vehicle according to claim 4, wherein the discrete zones are regularly spaced around the circumference of the tyre.

6. The remotely-operated vehicle according to claim 4, wherein the number of discrete zones is:
one or more; or
five or more; and/or
no greater than 100.

7. The remotely-operated vehicle according to claim 1, wherein the layer comprises an inner ring of one or more sprockets encased in an outer ring of a resilient material.

8. The remotely-operated vehicle according to claim 1, wherein one or more inner sprockets are sandwiched between two or more outer layers of resilient material.

9. The remotely-operated vehicle according to claim 1, wherein one or more inner sprockets are arranged beside a single layer of resilient material.

10. The remotely-operated vehicle according to claim 7, wherein the sprockets are composed of polymer and/or the resilient material is rubber.

11. The remotely-operated vehicle according to claim 7, wherein from each sprocket a discrete, sprung tooth passes radially towards the circumferential edge of the overlying outer ring of resilient material.

12. The remotely-operated vehicle according to claim 4, wherein each discrete zone is formed of a collapsible area.

13. The remotely-operated vehicle according to claim 12, wherein the one or more collapsible areas include at least one internal compartment within the layer.

14. The remotely-operated vehicle according to claim 13, wherein the at least one internal compartment communicates via one or more slits with the exterior surface of the layer.

15. The remotely-operated vehicle according to claim 13, wherein the at least one compartment is filled with a material of lower stiffness.

16. The remotely-operated vehicle according to claim 13, wherein the at least one compartment is empty.

17. The remotely-operated vehicle according to claim 14, wherein each compartment is adapted to collapse in use.

18. The remotely-operated vehicle according to claim 1 in which there are a plurality of layers.

19. The remotely-operated vehicle according to claim 18 in which at least two layers of the plurality have a stiffness in their radial direction which varies around the circumference of the tyre, the layers being aligned such that an area of elevated radial stiffness of one layer corresponds to an area of reduced radial stiffness of the other layer.

20. A wheel of a remotely-operated vehicle comprising a tyre having a layer whose stiffness in its radial direction varies around its circumference.

21. The wheel according to claim 20, wherein the tyre is non-pneumatic.

22. The wheel according to claim 20, wherein its radial stiffness varies so as to allow the tyre to grip one or more undulations in use.

23. The wheel according to claim 20, wherein the varying stiffness is effected by a localised reduction in stiffness in one or more discrete zones around the circumference of the tyre.

24. The wheel according to claim 23, wherein the discrete zones are regularly spaced around the circumference of the tyre.

25. The wheel according to claim 23, wherein the number of discrete zones is:
one or more; or
five or more; and/or
no greater than 100.

26. The wheel according to claim 20, wherein the layer comprises an inner ring of one or more sprockets encased in an outer ring of a resilient material.

27. The wheel according to claim 20, wherein one or more inner sprockets are sandwiched between two or more outer layers of resilient material.

28. The wheel according to claim 20, wherein one or more inner sprockets are arranged beside a single layer of resilient material.

29. The wheel according to claim 26, wherein the sprockets are composed of polymer and/or the resilient material is rubber.

30. The wheel according to claim 26, wherein from each sprocket a discrete, sprung tooth passes radially towards the circumferential edge of the overlying outer ring of resilient material.

31. The wheel according to claim 23, wherein each discrete zone is formed of a collapsible area.

32. The wheel according to claim 31, wherein the one or more collapsible areas include at least one internal compartment within the layer.

33. The wheel according to claim 32, wherein the at least one internal compartment communicates via one or more slits with the exterior surface of the layer.

34. The wheel according to claim 32, wherein the at least one compartment is filled with a material of lower stiffness.

35. The wheel according to claim 32, wherein the at least one compartment is empty.

36. The wheel according to claim 33, wherein each compartment is adapted to collapse in use.

37. The wheel according to claim 20 in which there are a plurality of layers.

38. The wheel according to claim 37 in which at least two layers of the plurality have a stiffness in their radial direction which varies around the circumference of the tyre, the layers being aligned such that an area of elevated radial stiffness of one layer corresponds to an area of reduced radial stiffness of the other layer.

39. A tyre adapted to fit one or more wheels of a remotely-operated vehicle, comprising a layer whose stiffness in its radial direction varies around its circumference.

40. The tyre according to claim 39, wherein the tyre is non-pneumatic.

41. The tyre according to claim 39, wherein its radial stiffness varies so as to allow the tyre to grip one or more undulations in use.

42. The tyre according to claim 39, wherein the varying stiffness is effected by a localised reduction in stiffness in one or more discrete zones around the circumference of the tyre.

43. The tyre according to claim 42, wherein the discrete zones are regularly spaced around the circumference of the tyre.

44. The tyre according to claim 42, wherein the number of discrete zones is:
one or more; or
five or more; and/or
no greater than 100.

45. The tyre according to claim 39, wherein the layer comprises an inner ring of one or more sprockets encased in an outer ring of a resilient material.

46. The tyre according to claim 39, wherein one or more inner sprockets are sandwiched between two or more outer layers of resilient material.

47. The tyre according to claim 39, wherein one or more inner sprockets are arranged beside a single layer of resilient material.

48. The tyre according to claim 45, wherein the sprockets are composed of polymer and/or the resilient material is rubber.

49. The tyre according to claim 45, wherein from each sprocket a discrete, sprung tooth passes radially towards the circumferential edge of the overlying outer ring of resilient material.

50. The tyre according to claim 42, wherein each discrete zone is formed of a collapsible area.

51. The tyre according to claim 50, wherein the one or more collapsible areas include at least one internal compartment within the layer.

52. The tyre according to claim 51, wherein the at least one internal compartment communicates via one or more slits with the exterior surface of the layer.

53. The tyre according to claim 51, wherein the at least one compartment is filled with a material of lower stiffness.

54. The tyre according to claim 51, wherein the at least one compartment is empty.

55. The tyre according to claim 52, wherein each compartment is adapted to collapse in use.

56. The tyre according to claim 39 in which there are a plurality of layers.

57. The tyre according to claim 56 in which at least two layers of the plurality have a stiffness in their radial direction which varies around the circumference of the tyre, the layers being aligned such that an area of elevated radial stiffness of one layer corresponds to an area of reduced radial stiffness of the other layer.
